(19) United States
(12) Patent Application Publication
(10) Pub. No.: US 2026/0364918 A1
(43) Pub. Date: Nov. 19, 2026

(54) METHODS FOR BONDING PLASTICS AND COMPONENTS MADE BY THE SAME

(71) Applicant: Truvian Sciences, Inc., San Diego, CA (US)

(72) Inventors: Eumene Lee, San Diego, CA (US); Tyson Grant, San Diego, CA (US); Steven Quintero, San Diego, CA (US)

(73) Assignee: Truvian Sciences, Inc., San Diego, CA (US)

(21) Appl. No.: 19/657,415

(22) Filed: Apr. 24, 2026

Related U.S. Application Data
(63) Continuation of application No. 18/025,376, filed on Sep. 22, 2021, now Pat. No. 12,636,859.
(60) Provisional application No. 63/081,588, filed on Sep. 22, 2020.

(51) Int. Cl. B32B 7/12; B32B 27/32; B32B 27/36; B32B 37/12; B32B 37/26

(52) U.S. Cl. CPC B32B 7/12; B32B 27/325; B32B 27/365; B32B 37/12; B32B 37/26; B32B 2250/24; B32B 2307/308

(57) ABSTRACT

Methods of bonding plastics are described herein. The method includes providing a substrate having a melting temperature in a first range, providing a bonding film having a melting temperature in the first range, providing an adhesive layer, providing an optical film having a melting temperature in a second range, laminating the bonding film, the adhesive layer, and optical film together, and bonding the laminate to the substrate. Another method includes providing the substrate and the optical film, coating the substrate with a thermal matching layer having a melting temperature in the second range, or coating the optical film with a thermal matching layer having a melting temperature in the first range, and bonding the thermal matching layer to the substrate or the optical film that is uncoated with the thermal matching layer. A difference between melting temperatures of the substrate and the optical film is about 50 to 250 °F.

### CROSS-REFERENCE TO RELATED APPLICATION(S)

This application claims benefit of priority under 35 U.S.C. § 119(e) of U.S. Provisional Patent Application Ser. No. 63/081,588, filed Sep. 22, 2020. The disclosure of the prior application is considered part of and is incorporated by reference in the disclosure of this application.

### BACKGROUND OF THE INVENTION

### Field of the Invention

The present disclosure relates generally to bonding of plastics, and more particularly to components having thermally dissimilar plastics and methods of bonding thermally dissimilar plastics, especially plastics having a difference in melting temperatures.

### Background Information

Thermally dissimilar plastics are difficult to bond to one another. Differences in melting points prevent the thermally dissimilar plastics from reliably bonding together, especially through thermal bonding processes like laser welding, thermal fusion bonding, and ultrasonic welding. Some materials, such as cyclic olefin polymer (COP) can become exceedingly brittle from thermal processing or solvent bonding, and as a result, expensive and time-consuming annealing processes need to be performed to make such materials viable for use. Therefore, there is a need for an inexpensive and practical component having thermally dissimilar plastics, as well as a method for bonding thermally dissimilar plastics together to form such a component.

### SUMMARY OF THE INVENTION

A component having thermally dissimilar plastics is described herein. In some embodiments, the component includes: a substrate having a melting temperature in a first temperature range; and a laminate bonded to the substrate. The laminate includes: a bonding film having a melting temperature in the first temperature range; an adhesive layer; and an optical film having a melting temperature in a second temperature range. In some embodiments, a difference between the melting temperature of the substrate and the melting temperature of the optical film is about 50 to 250 °F.

In some embodiments, the first temperature range is about 140 to 220 °F.

In some embodiments, the second temperature range is about 250 to 450 °F.

In some embodiments, the difference between the melting temperature of the substrate and the melting temperature of the optical film is about 100 to 200 °F.

In some embodiments, the substrate includes a polycarbonate.

In some embodiments, the bonding film includes a polycarbonate.

In some embodiments, the adhesive layer is a pressure sensitive adhesive, transfer adhesive, or other applied adhesive layer.

In some embodiments, the optical film includes a cyclic olefin polymer.

In some embodiments, the bonding film is in direct contact with the substrate.

In some embodiments, the substrate and the bonding film have a difference between melting temperatures of about 30 °F or less.

A method of bonding plastics is described herein. In some embodiments, the method of bonding plastics, includes: providing a substrate having a melting temperature in a first temperature range; providing a bonding film having a melting temperature in the first temperature range; providing an adhesive layer; providing an optical film having a melting temperature in a second temperature range; laminating the bonding film, the adhesive layer, and optical film together; and bonding the laminate to the substrate, wherein a difference between the melting temperature of the substrate and the melting temperature of the optical film is about 50 to 250 °F.

In some embodiments, the first temperature range is about 140 to 220 °F.

In some embodiments, the second temperature range is about 250 to 450 °F.

In some embodiments, the difference between the melting temperature of the substrate and the melting temperature of the optical film is about 100 to 200 °F.

In some embodiments, the substrate includes a polycarbonate.

In some embodiments, the bonding film includes a polycarbonate.

In some embodiments, the adhesive layer is a pressure sensitive adhesive layer, transfer adhesive layer, or other applied adhesive layer.

In some embodiments, the optical film includes a cyclic olefin polymer.

In some embodiments, the bonding the laminate to the substrate includes bonding the bonding film in direct contact with the substrate.

In some embodiments, the bonding the laminate to the substrate includes thermal bonding the laminate to the substrate.

In some embodiments, the bonding the laminate to the substrate includes laser welding the laminate to the substrate.

Also described herein is a component manufactured from the method described herein.

Another component is also described herein. In some embodiments, the component includes: a substrate having a melting temperature in a first temperature range; an optical film having a melting temperature in a second temperature range; and a thermal matching layer between the substrate and the optical film, the thermal matching layer having a melting temperature in the first temperature range, the second temperature range or between the first temperature range and the second temperature range, wherein a difference between the melting temperature of the substrate and the melting temperature of the optical film is about 50 to 250 °F.

In some embodiments, the first temperature range is about 140 to 220 °F.

In some embodiments, the second temperature range is about 250 to 450 °F.

In some embodiments, the difference between the melting temperature of the substrate and the melting temperature of the optical film is about 100 to 200 °F.

In some embodiments, the substrate includes a polycarbonate.

In some embodiments, the optical film includes a cyclic olefin polymer.

In some embodiments, the thermal matching layer includes at least one or both of acrylic and urethane.

In some embodiments, the thermal matching layer includes parylene.

In some embodiments, the thermal matching layer has a melting temperature in the second temperature range.

In some embodiments, the thermal matching layer has a melting temperature in the first temperature range.

Another method of bonding plastics is also described herein. In some embodiments, the method of bonding plastics, includes: providing a substrate having a melting temperature in a first temperature range; providing an optical film having a melting temperature in a second temperature range; coating the substrate with a thermal matching layer having a melting temperature in the second temperature range or between the first temperature range and the second temperature range, or coating the optical film with a thermal matching layer having a melting temperature in the first temperature range or between the first temperature range and the second temperature range; and bonding the thermal matching layer to the substrate or the optical film that is uncoated with the thermal matching layer, wherein a difference between the melting temperature of the substrate and the melting temperature of the optical film is about 50 to 250 °F.

In some embodiments, the first temperature range is about 140 to 220 °F.

In some embodiments, the second temperature range is about 250 to 450 °F.

In some embodiments, the difference between the melting temperature of the substrate and the melting temperature of the optical film is about 100 to 200 °F.

In some embodiments, the substrate includes a polycarbonate.

In some embodiments, the optical film includes a cyclic olefin polymer.

In some embodiments, the thermal matching layer includes at least one of acrylic and urethane.

In some embodiments, the thermal matching layer includes parylene.

In some embodiments, bonding the thermal matching layer to the substrate or the optical film that is uncoated with the thermal matching layer includes thermal bonding the thermal matching layer to the substrate or the optical film that is uncoated with the thermal matching layer.

In some embodiments, bonding the thermal matching layer to the substrate or the optical film that is uncoated with the thermal matching layer includes laser welding the thermal matching layer to the substrate or the optical film that is uncoated with the thermal matching layer.

In some embodiments, the method includes coating the substrate with a thermal matching layer having a melting temperature in the second temperature range or between the first temperature range and the second temperature range.

In some embodiments, the method includes coating the optical film with a thermal matching layer having a melting temperature in the first temperature range or between the first temperature range and the second temperature range.

Also described herein is a component manufactured from the method described herein.

### BRIEF DESCRIPTION OF THE FIGURES

FIG. 1 is a cross-sectional view of a component produced by a method of the present disclosure.

FIG. 2 is a cross-sectional view of a component produced by a method of the present disclosure.

### DETAILED DESCRIPTION

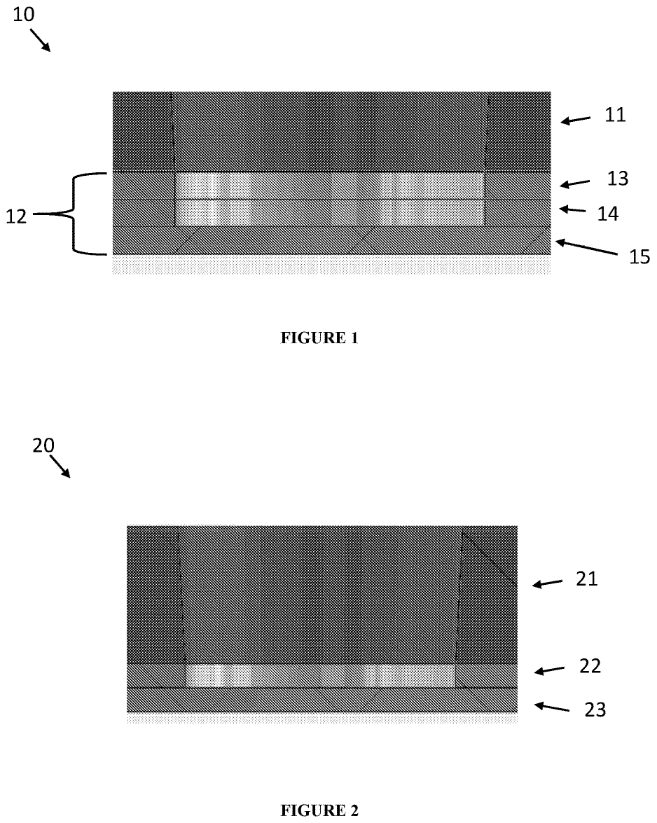

The disclosure provides a component having thermally dissimilar plastics. In some embodiments, as shown in FIG. 1, the component 10 includes: a substrate 11, such as a polycarbonate, having a melting temperature in a first temperature range; and a laminate 12 bonded to the substrate 11. The laminate 12 includes: a bonding film 13, such as a polycarbonate, having a melting temperature in the first temperature range; an adhesive layer 14, such as a pressure sensitive adhesive; and an optical film 15, such as COP, having a melting temperature in a second temperature range. In some embodiments, a difference between the melting temperature of the substrate and the melting temperature of the optical film is about 50 to 250 °F.

In some embodiments, the bonding film 13 and the adhesive layer 14 have cut outs so that optically, only the optical film 15 would be in an optical path of an analytical instrument. In some embodiments, the bonding film 13 can cover the entire surface of the optical film 15 or it may only be applied in regions that will form the bond with the substrate 11.

A method of bonding thermally dissimilar plastics is described herein. In some embodiments, the method of bonding plastics, includes: providing a substrate having a melting temperature in a first temperature range; providing a bonding film having a melting temperature in the first temperature range; providing an adhesive layer; providing an optical film having a melting temperature in a second temperature range; laminating the bonding film, the adhesive layer, and optical film together; and bonding the laminate to the substrate, wherein a difference between the melting temperature of the substrate and the melting temperature of the optical film is about 50 to 250 °F.

In some embodiments, the method produces a component 10 having thermally dissimilar plastics as described herein. The following paragraphs describe the component 10 having thermally dissimilar plastics and the method of bonding thermally dissimilar plastics in conjunction.

In some embodiments, the substrate 11 has a melting temperature within a first temperature range. In some embodiments, the substrate 11 has a melting temperature within a first temperature range of about 140 to 220 °F. In some embodiments, the first temperature range is about 250 to 450 °F.

In some embodiments, the bonding film 13 has a melting temperature within the same first temperature range. In some embodiments, the bonding film 13 has a melting temperature within a first temperature range of about 140 to 220 °F. In some embodiments, the first temperature range is about 250 to 450 °F.

Without being bound to any particular theory, the substrate 11 and the bonding film 13 have melting temperatures that are similar to allow for reliably joining and bonding of the substrate 11 and the bonding film 13. Differences in melting points prevent the substrate 11 and the bonding film 13 from reliably bonding together, especially through thermal bonding processes like laser welding, thermal fusion bonding, and ultrasonic welding.

In some embodiments, the substrate 11 and the bonding film 13 have a difference between melting temperatures of about 80 °F or less. In some embodiments, the substrate 11 and the bonding film 13 have a difference between melting temperatures of about 70 °F or less. In some embodiments, the substrate 11 and the bonding film 13 have a difference between melting temperatures of about 60 °F or less. In some embodiments, the substrate 11 and the bonding film 13 have a difference between melting temperatures of about 50 °F or less. In some embodiments, the substrate 11 and the bonding film 13 have a difference between melting temperatures of about 40 °F or less. In some embodiments, the substrate 11 and the bonding film 13 have a difference between melting temperatures of about 30 °F or less. In some embodiments, the substrate 11 and the bonding film 13 have a difference between melting temperatures of about 20 °F or less. In some embodiments, the substrate 11 and the bonding film 13 have a difference between melting temperatures of about 10 °F or less. In some embodiments, the substrate 11 and the bonding film 13 have a difference between melting temperatures of about 5 °F or less.

The substrate 11 can be made from any suitable plastic not inconsistent with the objectives of the present disclosure. In some embodiments, the substrate 11 is composed of polypropylene, polyvinylbutyrale, polyamide, polyamide 12, polyarylate, parylene, polyether ether ketone, polybenzimidazole, polyamide-imide, thermoplastic polyimide, liquid crystal polymer (such as Kevlar™, Vectran™ and Zenite™), polyphthalamide, polycarbonate, polystyrene, polysulfone, polyimide, polyphenolsulfone, polyetherimide, polyether sulfone, polyarylethersulfone, poly(bisphenol-A sulfone), polyarylene sulfone, polyethylene, polyester, vinyl, poly(vinylchloride) (PVC), polyurethane, polyvinyldiene chloride, cyclic olefin polymer (COP), cyclic olefin copolymer (COC), polycarbonate-polyethylene terephthalate-blends, polycarbonatepolybutylene terephthalate-blends, polycarbonate-acrylnitrile/styrene/acrylnitrile-copolymer-blends, polycarbonate-acrylnitrile/butadiene/styrene-copolymer-blends, polymethylmethacrylate-acrylnitrile/butadiene/styrene-copolymer-blends (MABS), polyethylene terephthalate, polybutylene terephthalate, polymethylmethacrylate, polybutylacrylate, polymethylmethacrylate-polyvinylidenedifluoride-blends, acrylnitrile/butadiene/styrene-copolymere (ABS), styrene/acrylnitrile-copolymere (SAN), Victrex™ HTA, and polyphenylenesulfone, or any combination thereof. In one embodiment, the substrate 11 includes a polycarbonate.

The bonding film 13 can be made from any suitable plastic not inconsistent with the objectives of the present disclosure. In some embodiments, the bonding film 13 is composed of polypropylene, polyvinylbutyrale, polyamide, polyamide 12, polyarylate, parylene, polyether ether ketone, polybenzimidazole, polyamide-imide, thermoplastic polyimide, liquid crystal polymer (such as Kevlar™, Vectran™ and Zenite™), polyphthalamide, polycarbonate, polystyrene, polysulfone, polyimide, polyphenolsulfone, polyetherimide, polyether sulfone, polyarylethersulfone, poly(bisphenol-A sulfone), polyarylene sulfone, polyethylene, polyester, vinyl, poly(vinylchloride) (PVC), polyurethane, polyvinyldiene chloride, cyclic olefin polymer (COP), cyclic olefin copolymer (COC), polycarbonate-polyethylene terephthalate-blends, polycarbonatepolybutylene terephthalate-blends, polycarbonate-acrylnitrile/styrene/acrylnitrile-copolymer-blends, polycarbonate-acrylnitrile/butadiene/styrene-copolymer-blends, polymethylmethacrylate-acrylnitrile/butadiene/styrene-copolymer-blends (MABS), polyethylene terephthalate, polybutylene terephthalate, polymethylmethacrylate, polybutylacrylate, polymethylmethacrylate-polyvinylidenedifluoride-blends, acrylnitrile/butadiene/styrene-copolymere (ABS), styrene/acrylnitrile-copolymere (SAN), polyphenylenesulfone, Victrex™ HTA, or any combination thereof. In one embodiment, the bonding film 13 includes a polycarbonate.

In some embodiments, the substrate 11 and the bonding film 13 both comprise a polycarbonate. Without being bound to any particular theory, the substrate 11 and the bonding film 13 both including polycarbonate allow for melting temperatures that are similar, thereby reliably joining and bonding the substrate 11 and the bonding film 13 together. In other embodiments, the substrate 11 and the bonding film 13 can be composed of other suitable plastic materials having melting temperatures that are similar to one another as outlined in the paragraphs above.

The thickness of the bonding film 13 is not particularly limited. However, in some embodiments, the thickness is about 10 μm to about 500 μm, including for example, about 50 μm to 250 μm, and about 150 μm to 250 μm.

In some embodiments, the optical film 15 has a melting temperature within a second temperature range. In some embodiments, the optical film 15 has a melting temperature within a second temperature range of about 250 to 450 °F. In some embodiments, the second temperature range is about 140 to 220 °F.

The optical film 15 can be made from any suitable plastic not inconsistent with the objectives of the present disclosure. In some embodiments, the optical film 15 is composed of polypropylene, polyvinylbutyrale, polyamide, polyamide 12, polyarylate, parylene, polyether ether ketone, polybenzimidazole, polyamide-imide, thermoplastic polyimide, liquid crystal polymer (such as Kevlar™, Vectran™ and Zenite™), polyphthalamide, polycarbonate, polystyrene, polysulfone, polyimide, polyphenolsulfone, polyetherimide, polyether sulfone, polyarylethersulfone, poly(bisphenol-A sulfone), polyarylene sulfone, polyethylene, polyester, vinyl, poly(vinylchloride) (PVC), polyurethane, polyvinyldiene chloride, cyclic olefin polymer (COP), cyclic olefin copolymer (COC), polycarbonate-polyethylene terephthalate-blends, polycarbonatepolybutylene terephthalate-blends, polycarbonate-acrylnitrile/styrene/acrylnitrile-copolymer-blends, polycarbonate-acrylnitrile/butadiene/styrene-copolymer-blends, polymethylmethacrylate-acrylnitrile/butadiene/styrene-copolymer-blends (MABS), polyethylene terephthalate, polybutylene terephthalate, polymethylmethacrylate, polybutylacrylate, polymethylmethacrylate-polyvinylidenedifluoride-blends, acrylnitrile/butadiene/styrene-copolymere (ABS), styrene/acrylnitrile-copolymere (SAN), and polyphenylenesulfone, or any combination thereof. In some embodiments, the optical film 15 is composed of cyclic olefin polymer, polyimide, polyphenolsulfone, polyetherimide, polysulfone, polyether sulfone, polyarylethersulfone, poly(bisphenol-A sulfone), polyarylene sulfone, polyamide 12, polyarylate, parylene, polyether ether ketone, polybenzimidazole, polyamide-imide, thermoplastic polyimide, liquid crystal polymer (such as Kevlar™, Vectran™ and Zenite™), polyphthalamide, Victrex™ HTA, or any combination thereof. In one embodiment, the optical film 15 includes a cyclic olefin polymer.

The thickness of the optical film 15 is not particularly limited. However, in some embodiments, the thickness is about 10 μm to about 500 μm, including for example, about 50 μm to 250 μm, and about 150 μm to 250 μm.

In some embodiments, a difference between the melting temperature of the substrate 11 and the melting temperature of the optical film 15 is about 50 to 250 °F. In some embodiments, the difference between the melting temperature of the substrate 11 and the melting temperature of the optical film 15 is about 100 to 200 °F. In some embodiments, the difference between the melting temperature of the substrate 11 and the melting temperature of the optical film 15 is about 125 to 175 °F. In some embodiments, the difference between the melting temperature of the substrate 11 and the melting temperature of the optical film 15 is about 140 to 160 °F. In some embodiments, the difference between the melting temperature of the substrate 11 and the melting temperature of the optical film 15 is about 150 °F.

In some embodiments, the adhesive layer 14 is a pressure sensitive adhesive layer 14. In other embodiments, the adhesive layer 14 can be formed from a transfer adhesive, liquid adhesive, or a solvent bond, i.e., a transfer adhesive layer, a liquid adhesive layer, or a solvent bond layer. The pressure sensitive adhesive that is used to form the adhesive layer 14 is not especially limited. Examples include a general pressure sensitive adhesive such as an acrylic pressure-sensitive adhesive, silicone pressure-sensitive adhesive, and a rubber-based pressure sensitive adhesive. For some embodiments, as the pressure-sensitive adhesive, an acrylic pressure sensitive adhesive having an acrylic polymer as a base polymer is utilized.

Examples of the acrylic polymer include acrylic polymers using, as a monomer component, one or more types of (meth)acrylic acid alkyl esters (for example, a straight chain or branched chain alkyl ester having 1 to 30 carbon atoms, and particularly 4 to 18 carbon atoms in the alkyl group such as methylester, ethylester, propylester, isopropylester, butylester, isobutylester, sec-butylester, t-butylester, pentylester, isopentylester, hexylester, heptylester, octylester, 2-ethylhexylester, isooctylester, nonylester, decylester, isodecylester, undecylester, dodecylester, tridecylester, tetradecylester, hexadecylester, octadecylester, and eicosylester) and (meth)acrylic acid cycloalkyl esters (for example, cyclopentylester, cyclohexylester, etc.). The (meth)acrylic acid ester means an acrylic acid ester and/or a methacrylic acid ester and has the very same meaning as (meth) in the present disclosure.

The acrylic polymer may optionally contain a unit corresponding to a different monomer component copolymerizable with the above-mentioned alkyl ester of (meth)acrylic acid or cycloalkyl ester thereof in order to improve the cohesive force, heat resistance or some other property of the polymer. Examples of such a monomer component include carboxyl-containing monomers such as acrylic acid, methacrylic acid, carboxyethyl (meth)acrylate, carboxypentyl (meth)acrylate, itaconic acid, maleic acid, fumaric acid, and crotonic acid; acid anhydride monomers such as maleic anhydride, and itaconic anhydride; hydroxyl-containing monomers such as 2-hydroxyethyl (meth)acrylate, 2-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, and (4-hydroxylmethylcyclohexyl)methyl (meth)acrylate; sulfonic acid group containing monomers such as styrenesulfonic acid, allylsulfonic acid, 2-(meth)acrylamide-2-methylpropanesulfonic acid, (meth)acrylamidepropanesulfonic acid, sulfopropyl (meth)acrylate, and (meth)acryloyloxynaphthalenesulfonic acid; phosphoric acid group containing monomers such as 2-hydroxyethylacryloyl phosphate; acrylamide; and acrylonitrile. These copolymerizable monomer components may be used alone or in combination of two or more thereof. The amount of the copolymerizable monomer(s) to be used is about 40% or less by weight of all the monomer components.

For crosslinking, the acrylic polymer can also contain multifunctional monomers if necessary, as the copolymerizable monomer component. Such multifunctional monomers include hexane diol di(meth)acrylate, (poly)ethylene glycol di(meth)acrylate, (poly)propylene glycol di(meth)acrylate, neopentyl glycol di(meth)acrylate, pentaerythritol di(meth)acrylate, trimethylol propane tri(meth)acrylate, pentaerythritol tri(meth)acrylate, dipentaerythritol hexa(meth)acrylate, epoxy (meth)acrylate, polyester (meth)acrylate, urethane (meth)acrylate etc. These multifunctional monomers can also be used as a mixture of one or more thereof.

From the viewpoint of adhesiveness, the use amount of the multifunctional monomer is about 30 wt % or less based on the whole monomer components.

The thickness of the adhesive layer 14 is not particularly limited. However, in some embodiments, the thickness is about 10 μm to about 500 μm including for example, about 50 μm to 250 μm, and about 50 μm to 200 μm.

The method further includes laminating the bonding film 13, the adhesive layer 14, and optical film 15 together. In some embodiments, the bonding film 13, the adhesive layer 14, and optical film 15 are laminated sequentially as listed. The process for laminating the bonding film 13, the adhesive layer 14, and optical film 15 together is not especially limited. Any laminating process not inconsistent with the objectives of the present disclosure can be used.

The method further includes bonding the laminate 12 to the substrate. In some embodiments, bonding the laminate 12 to the substrate 11 includes bonding the bonding film 13 in direct contact with the substrate. In some embodiments, the bonding the laminate 12 to the substrate 11 includes thermal bonding the laminate 12 to the substrate. Any thermal bonding process not inconsistent with the objectives of the present disclosure can be used.

Non-limiting examples include laser welding, thermal fusion bonding, and ultrasonic welding. In some embodiments, the bonding the laminate 12 to the substrate 11 includes laser welding the laminate 12 to the substrate.

Without being bound to any particular theory, differences in melting points, for example, about 50 to 250 °F, prevent the substrate 11 and the optical film 15 from reliably bonding together, especially bonding the substrate 11 and the optical film 15 through thermal bonding processes. By laminating the optical film 15 to a bonding film 13 and an adhesive layer 14 and bonding the laminate 12 to the substrate, the optical film 15 can be reliably joined together with the substrate 11 because the bonding film 13 and the substrate 11 have similar melting temperatures.

Also described herein is a component manufactured from the method described herein. As shown in FIG. 1, the component 10 includes a substrate 11 and a laminate 12. The laminate 12 includes a bonding film 13, an adhesive layer 14, and an optical film 15. In some embodiments, the bonding film 13 and the adhesive layer 14 have cut outs so that optically, only the optical film 15 would be in an optical path of an analytical instrument. In some embodiments, the bonding film 13 can cover the entire surface of the optical film 15 or it may only be applied in regions that will form the bond with the substrate 11.

The bonding film 13 is thermally bonded to the substrate 11. In some embodiments, the bonding film 13 is thermally bonded to the substrate 11 using laser welding.

Another component is described herein. In some embodiments, as shown in FIG. 2, the component 20 includes: a substrate 21, such as a polycarbonate, having a melting temperature in a first temperature range; an optical film 23, such as COP, having a melting temperature in a second temperature range; and a thermal matching layer 22 between the substrate and the optical film having a melting temperature in the first temperature range the second temperature range, or between the first temperature range and the second temperature range, wherein a difference between the melting temperature of the substrate 21 and the melting temperature of the optical film 23 is about 50 to 250 °F. In some embodiments, the thermal matching layer 22 has cut outs so that optically only the optical film 23 would be seen by analytical instruments.

Another method of bonding plastics is described herein. In some embodiments, the method of bonding plastics, includes: providing a substrate 21 having a melting temperature in a first temperature range; providing an optical film 23 having a melting temperature in a second temperature range; coating the substrate 21 with a thermal matching layer 22 having a melting temperature in the second temperature range, or coating the optical film 23 with a thermal matching layer 22 having a melting temperature in the first temperature range; and bonding the thermal matching layer 22 to the substrate 21 or the optical film 23 that is uncoated with the thermal matching layer 22, wherein a difference between the melting temperature of the substrate 21 and the melting temperature of the optical film 23 is about 50 to 250 °F.

In some embodiments, the method can produce a component 20 having thermally dissimilar plastics as described herein. The following paragraphs describe the component 20 having thermally dissimilar plastics and the method of bonding thermally dissimilar plastics in conjunction.

The substrate 21 has a melting temperature within a first temperature range. In some embodiments, the substrate 21 has a melting temperature within a first temperature range of about 140 to 220 °F. In some embodiments, the first temperature range is about 250 to 450 °F.

The substrate 21 can be made from any suitable plastic not inconsistent with the objectives of the present disclosure. In some embodiments, the substrate 21 is composed of polypropylene, polyvinylbutyrale, polyamide, polyamide 12, polyarylate, parylene, polyether ether ketone, polybenzimidazole, polyamide-imide, thermoplastic polyimide, liquid crystal polymer (such as Kevlar™, Vectran™ and Zenite™), polyphthalamide, polycarbonate, polystyrene, polysulfone, polyimide, polyphenolsulfone, polyetherimide, polyether sulfone, polyarylethersulfone, poly(bisphenol-A sulfone), polyarylene sulfone, polyethylene, polyester, vinyl, poly(vinylchloride) (PVC), polyurethane, polyvinyldiene chloride, cyclic olefin polymer (COP), cyclic olefin copolymer (COC), polycarbonate-polyethylene terephthalate-blends, polycarbonatepolybutylene terephthalate-blends, polycarbonate-acrylnitrile/styrene/acrylnitrile-copolymer-blends, polycarbonate-acrylnitrile/butadiene/styrene-copolymer-blends, polymethylmethacrylate-acrylnitrile/butadiene/styrene-copolymer-blends (MABS), polyethylene terephthalate, polybutylene terephthalate, polymethylmethacrylate, polybutylacrylate, polymethylmethacrylate-polyvinylidenedifluoride-blends, acrylnitrile/butadiene/styrene-copolymere (ABS), styrene/acrylnitrile-copolymere (SAN), Victrex™ HTA, and polyphenylenesulfone, or any combination thereof. In one embodiment, the substrate 21 includes a polycarbonate.

The optical film 23 has a melting temperature within a second temperature range.

In some embodiments, the optical film 23 has a melting temperature within a second temperature range of about 250 to 450 °F. In some embodiments, the second temperature range is about 140 to 220 °F.

The optical film 23 can be made from any suitable plastic not inconsistent with the objectives of the present disclosure. In some embodiments, the optical film 23 is composed of polypropylene, polyvinylbutyrale, polyamide, polyamide 12, polyarylate, parylene, polyether ether ketone, polybenzimidazole, polyamide-imide, thermoplastic polyimide, liquid crystal polymer (such as Kevlar™, Vectran™ and Zenite™), polyphthalamide, polycarbonate, polystyrene, polysulfone, polyimide, polyphenolsulfone, polyetherimide, polyether sulfone, polyarylethersulfone, poly(bisphenol-A sulfone), polyarylene sulfone, polyethylene, polyester, vinyl, poly(vinylchloride) (PVC), polyurethane, polyvinyldiene chloride, cyclic olefin polymer (COP), cyclic olefin copolymer (COC), polycarbonate-polyethylene terephthalate-blends, polycarbonatepolybutylene terephthalate-blends, polycarbonate-acrylnitrile/styrene/acrylnitrile-copolymer-blends, polycarbonate-acrylnitrile/butadiene/styrene-copolymer-blends, polymethylmethacrylate-acrylnitrile/butadiene/styrene-copolymer-blends (MABS), polyethylene terephthalate, polybutylene terephthalate, polymethylmethacrylate, polybutylacrylate, polymethylmethacrylate-polyvinylidenedifluoride-blends, acrylnitrile/butadiene/styrene-copolymere (ABS), styrene/acrylnitrile-copolymere (SAN), Victrex™ HTA, and polyphenylenesulfone, or any combination thereof. In some embodiments, the optical film 23 is composed of cyclic olefin polymer, polyimide, polyphenolsulfone, polyetherimide, polysulfone, polyether sulfone, polyarylethersulfone, poly(bisphenol-A sulfone), polyarylene sulfone, polyamide 12, polyarylate, parylene, polyether ether ketone, polybenzimidazole, polyamide-imide, thermoplastic polyimide, liquid crystal polymer (such as Kevlar™, Vectran™ and Zenite™), polyphthalamide, Victrex™ HTA, or any combination thereof. In one embodiment, the bonding film 23 includes a cyclic olefin polymer.

The thickness of the optical film 23 is not particularly limited. However, some in embodiments, the thickness is about 10 μm to about 500 μm including for example, about 50 μm to 250 μm, and about 150 μm to 250 μm.

In some embodiments, a difference between the melting temperature of the substrate 21 and the melting temperature of the optical film 23 is about 50 to 250 °F. In some embodiments, the difference between the melting temperature of the substrate 21 and the melting temperature of the optical film 23 is about 100 to 200 °F. In some embodiments, the difference between the melting temperature of the substrate 21 and the melting temperature of the optical film 23 is about 125 to 175 °F. In some embodiments, the difference between the melting temperature of the substrate 21 and the melting temperature of the optical film 23 is about 140 to 160 °F. In some embodiments, the difference between the melting temperature of the substrate 21 and the melting temperature of the optical film 23 is about 150 °F.

The method further includes coating the substrate 21 with a thermal matching layer 22 having a melting temperature in the second temperature range, or coating the optical film 23 with a thermal matching layer 22 having a melting temperature in the first temperature range. The thermal matching layer 22 can be made from any suitable polymer not inconsistent with the objectives of the present disclosure. That is, the thermal matching layer 22 can be made from any suitable polymer having a melting temperature in the second temperature range when coated on the substrate, or the thermal matching layer 22 can be made from any suitable polymer having a melting temperature in the first temperature range when coated on the optical film. In some embodiments, the thermal matching layer 22 includes at least one of acrylic and urethane. In some embodiments, the thermal matching layer 22 includes parylene.

In some embodiments, the substrate 21 is coated with the thermal matching layer 22 having a melting temperature in the second temperature range. In some embodiments, the thermal matching layer 22 and the optical film 23 have a difference between melting temperatures of about 80 °F or less. In some embodiments, the substrate 21 and the optical film 23 have a difference between melting temperatures of about 70 °F or less. In some embodiments, the substrate 21 and the optical film 23 have a difference between melting temperatures of about 60 °F or less. In some embodiments, the substrate 21 and the optical film 23 have a difference between melting temperatures of about 50 °F or less. In some embodiments, the substrate 21 and the optical film 23 have a difference between melting temperatures of about 40 °F or less. In some embodiments, the substrate 21 and the optical film 23 have a difference between melting temperatures of about 30 °F or less. In some embodiments, the substrate 21 and the optical film 23 have a difference between melting temperatures of about 20 °F or less. In some embodiments, the substrate 21 and the optical film 23 have a difference between melting temperatures of about 10 °F or less. In some embodiments, the substrate 21 and the optical film 23 have a difference between melting temperatures of about 5 °F or less.

In some embodiments, the optical film 23 is coated with the thermal matching layer 22 having a melting temperature in the first temperature range. In some embodiments, the thermal matching layer 22 and the substrate 21 have a difference between melting temperatures of about 80 °F or less. In some embodiments, the thermal matching layer 22 and the substrate 21 have a difference between melting temperatures of about 70 °F or less.

In some embodiments, the thermal matching layer 22 and the substrate 21 have a difference between melting temperatures of about 60 °F or less. In some embodiments, the thermal matching layer 22 and the substrate 21 have a difference between melting temperatures of about 50 °F or less. In some embodiments, the thermal matching layer 22 and the substrate 21 have a difference between melting temperatures of about 40 °F or less. In some embodiments, the thermal matching layer 22 and the substrate 21 have a difference between melting temperatures of about 30 °F or less. In some embodiments, the thermal matching layer 22 and the substrate 21 have a difference between melting temperatures of about 20 °F or less. In some embodiments, the thermal matching layer 22 and the substrate 21 have a difference between melting temperatures of about 10 °F or less. In some embodiments, the thermal matching layer 22 and the substrate 21 have a difference between melting temperatures of about 5 °F or less.

Without being bound to any particular theory, differences in melting points, for example, about 50 to 250 °F, prevent the substrate 21 and the optical film 23 from reliably bonding together, especially bonding the substrate 21 and the optical film 23 through thermal bonding processes. By coating the substrate 21 with a thermal matching layer 22 having a melting temperature in the second temperature range, or coating the optical film 23 with a thermal matching layer 22 having a melting temperature in the first temperature range, the optical film 23 can be reliably joined together with the substrate 21 because the thermal matching layer 22 has a similar melting temperature as the substrate 21 or the optical film 23 to which it is to be bonded.

The thickness of the thermal matching layer 22 is not particularly limited. However, in some embodiments, the thickness is about 10 μm to about 500 μm including for example, about 50 μm to 250 μm, and about 50 μm to 200 μm.

Any coating application process not inconsistent with the objectives of the present disclosure can be used. Non-limiting examples include, but are not limited to, pad printing, vapor deposition, spray coating, direct printing, or any other method for introducing a thin uniform layer of thermal matching coating.

The bond between the thermal matching layer 22 and the coated surface can be any bond not inconsistent with the objectives of the present disclosure. For some embodiments, the bond between the thermal matching layer 22 and the coated surface can be a mechanical or chemical bond.

The method further includes bonding the thermal matching layer 22 to the substrate 21 or the optical film 23 that is uncoated with the thermal matching layer 22. In some embodiments, the thermal matching layer 22 is bonded to the substrate 21 as the thermal matching layer 22 is coated on the optical film. In some embodiments, the thermal matching layer 22 is bonded to the optical film 23 as the thermal matching layer 22 is coated on the substrate.

In some embodiments, bonding the thermal matching layer 22 to the substrate 21 or the optical film 23 that is uncoated with the thermal matching layer 22 includes thermal bonding the thermal matching layer 22 to the substrate 21 or the optical film 23 that is uncoated with the thermal matching layer 22. Any thermal bonding process not inconsistent with the objectives of the present disclosure can be used. Non-limiting examples include laser welding, thermal fusion bonding, and ultrasonic welding. In some embodiments, bonding the thermal matching layer 22 to the substrate 21 or the optical film 23 that is uncoated with the thermal matching layer 22 includes laser welding the thermal matching layer 22 to the substrate 21 or the optical film 23 that is uncoated with the thermal matching layer 22.

Also described herein is a component manufactured from the method described herein. As shown in FIG. 2, the component 20 includes a substrate 21 a thermal matching layer 22, and an optical film 23. In some embodiments, the thermal matching layer 22 has cut outs so that optically only the optical film 23 would be in an optical path of an analytical instrument.

The thermal matching layer 22 is thermally bonded to the substrate 21. In some embodiments, the thermal matching layer 22 is thermally bonded to the substrate 21 using laser welding.

In the descriptions above and in the claims, phrases such as “at least one of” or “one or more of” can occur followed by a conjunctive list of elements or features. The term “and/or” can also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. For example, while the current subject matter is described as being used in connection with optical analytical devices and systems, it will be appreciated that the devices, components and systems described herein can be used with other types of analytical devices and systems, or in any technological field that utilizes bonded plastics. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results.

Although the invention has been described with reference to the above examples, it will be understood that modifications and variations are encompassed within the spirit and scope of the invention.

What is claimed is:

1. A component comprising:
a substrate having a melting temperature in a first temperature range; and
a laminate bonded to the substrate, the laminate comprising:
a bonding film having a melting temperature in the first temperature range;
an adhesive layer; and
an optical film having a melting temperature in a second temperature range,
wherein a difference between the melting temperature of the substrate and the melting temperature of the optical film is about 50 to 250 °F.

2. The component according to claim 1, wherein the first temperature range is about 140 to 220 °F.

3. The component according to any of the preceding claims, wherein the second temperature range is about 250 to 450 °F.

4. The component according to any of the preceding claims, wherein the difference between the melting temperature of the substrate and the melting temperature of the optical film is about 100 to 200 °F.

5. The component according to any of the preceding claims, wherein the substrate comprises a polycarbonate.

6. The component according to any of the preceding claims, wherein the bonding film comprises a polycarbonate.

7. The component according to any of the preceding claims, wherein the adhesive layer is a pressure sensitive adhesive layer.

8. The component according to any of the preceding claims, wherein the optical film comprises a cyclic olefin polymer.

9. The component according to any of the preceding claims, wherein the bonding film is in direct contact with the substrate.

10. The component according to any of the preceding claims, wherein the substrate and the bonding film have a difference between melting temperatures of about 30 °F or less.

11. A method comprising:
providing a substrate having a melting temperature in a first temperature range;
providing a bonding film having a melting temperature in the first temperature range;
providing an adhesive layer;
providing an optical film having a melting temperature in a second temperature range;
laminating the bonding film, the adhesive layer, and optical film together; and
bonding the laminate to the substrate, wherein a difference between the melting temperature of the substrate and the melting temperature of the optical film is about 50 to 250 °F.

12. The method according to claim 11, wherein the first temperature range is about 140 to 220 °F.

13. The method according to any of claims 11-12, wherein the second temperature range is about 250 to 450 °F.

14. The method according to any of claims 11-13, wherein the difference between the melting temperature of the substrate and the melting temperature of the optical film is about 100 to 200 °F.

15. The method according to any of claims 11-14, wherein the substrate comprises a polycarbonate.

16. The method according to any of claims 11-15, wherein the bonding film comprises a polycarbonate.

17. The method according to any of claims 11-16, wherein the adhesive layer is a pressure sensitive adhesive layer.

18. The method according to any of claims 11-17, wherein the optical film comprises a cyclic olefin polymer.

19. The method according to any of claims 11-18, wherein the bonding the laminate to the substrate includes bonding the bonding film in direct contact with the substrate.

20. The method according to any of claims 11-19, wherein the bonding the laminate to the substrate comprises thermal bonding the laminate to the substrate.

21. The method according to any of claims 11-20, wherein the bonding the laminate to the substrate comprises laser welding the laminate to the substrate.

22. A component manufactured from the method according to any of the preceding claims.

23. A component comprising:
a substrate having a melting temperature in a first temperature range;
an optical film having a melting temperature in a second temperature range; and
a thermal matching layer between the substrate and the optical film having a melting temperature in the first temperature range, the second temperature range, or between the first temperature range and the second temperature range, wherein a difference between the melting temperature of the substrate and the melting temperature of the optical film is about 50 to 250 °F.

24. The component according to claim 23, wherein the first temperature range is about 140 to 220 °F.

25. The component according to any of claims 23-24, wherein the second temperature range is about 250 to 450 °F.

26. The component according to any of claims 23-25, wherein the difference between the melting temperature of the substrate and the melting temperature of the optical film is about 100 to 200 °F.

27. The component according to any of claims 23-26, wherein the substrate comprises a polycarbonate.

28. The component according to any of claims 23-27, wherein the optical film comprises a cyclic olefin polymer.

29. The component according to any of claims 23-28, wherein the thermal matching layer comprises at least one or both of acrylic and urethane.

30. The component according to any of claims 23-28, wherein the thermal matching layer comprises parylene.

31. The component according to any of claims 23-30, wherein the thermal matching layer has a melting temperature in the second temperature range.

32. The component according to any of claims 23-30, wherein the thermal matching layer has a melting temperature in the first temperature range.

33. A method, comprising:
providing a substrate having a melting temperature in a first temperature range;
providing an optical film having a melting temperature in a second temperature range;
coating the substrate with a thermal matching layer having a melting temperature in the second temperature range, or coating the optical film with a thermal matching layer having a melting temperature in the first temperature range; and
bonding the thermal matching layer to the substrate or the optical film that is uncoated with the thermal matching layer,
wherein a difference between the melting temperature of the substrate and the melting temperature of the optical film is about 50 to 250 °F.

34. The method according to claim 33, wherein the first temperature range is about 140 to 220 °F.

35. The method according to any of claims 33-34, wherein the second temperature range is about 250 to 450 °F.

36. The method according to any of claims 33-35, wherein the difference between the melting temperature of the substrate and the melting temperature of the optical film is about 100 to 200 °F.

37. The method according to any of claims 33-36, wherein the substrate comprises a polycarbonate.

38. The method according to any of claims 33-37, wherein the optical film comprises a cyclic olefin polymer.

39. The method according to any of claims 33-38, wherein the thermal matching layer comprises at least one of acrylic and urethane.

40. The method according to any of claims 33-38, wherein the thermal matching layer comprises parylene.

41. The method according to any of claims 33-40, wherein the bonding the thermal matching layer to the substrate or the optical film that is uncoated with the thermal matching layer includes thermal bonding the thermal matching layer to the substrate or the optical film that is uncoated with the thermal matching layer.

42. The method according to any of claims 33-41, wherein the bonding the thermal matching layer to the substrate or the optical film that is uncoated with the thermal matching layer includes laser welding the thermal matching layer to the substrate or the optical film that is uncoated with the thermal matching layer.

43. The method according to any of claims 33-42, wherein the method includes the coating the substrate with the thermal matching layer having a melting temperature in the second temperature range.

44. The method according to any of claims 33-42, wherein the method includes the coating the optical film with the thermal matching layer having a melting temperature in the first temperature range.

45. A component manufactured by the method according to any of claims 33-44.
